(19) United States
(12) Patent Application Publication
(10) Pub. No.: US 2014/0030402 A1
(43) Pub. Date: Jan. 30, 2014

(54) TREATING PRODUCE TO REDUCE BROWNING AND IMPROVE QUALITY

(71) Applicant: Dole Fresh Vegetables, Inc., Salinas, CA (US)

(72) Inventors: Abizer KHAIRULLAH, Morgan Hill, CA (US); Bob J. DULL, Akron, OH (US); Jose Emilio VILLARREAL LOZOYA, Seaside, CA (US); Yuki MIKOSHIBA, Salinas, CA (US); Jonna THOMAS, Hollister, CA (US)

(73) Assignee: DOLE FRESH VEGETABLES, INC., Salinas, CA (US)

(21) Appl. No.: 13/725,971

(22) Filed: Dec. 21, 2012

Related U.S. Application Data
(63) Continuation of application No. 13/464,882, filed on May 4, 2012, now abandoned.
(60) Provisional application No. 61/483,381, filed on May 6, 2011.

(51) Int. Cl. A23B 7/005; A23B 7/153

(52) U.S. Cl. CPC A23B 7/0053; A23B 7/153
USPC 426/326; 426/324

(57) ABSTRACT

A method treating commercial produce to reduce browning and improve marketable shelf-life, the method involves submerging produce, with tissue previously wounded during processing, in a liquid at a temperature between 95 F and 103° F. for 180 seconds or less at pressures ranging between 0.5 to 3 psig, and preferably at 1.5 psig; the produce is then removed from the liquid; submersed in chilled water to cool the produce; dewatered; and packed in an oxygen-controlled package for commercial sale.

### CROSS REFERENCE TO RELATED APPLICATIONS

This application is a Continuation of U.S. patent application Ser. No. 13/464,882, with a filing date of May 4, 2012, which claims the benefit of U.S. Provisional Patent Application No. 61/483,381, filed May 6, 2011, all of which are hereby incorporated by reference in the present disclosure in their entirety.

### BACKGROUND

1. Field

The present disclosure relates to treating produce, and more particularly, to commercial treatment of produce to reduce browning and improve quality, resulting in longer marketable shelf-life.

2. Related Art

Fresh produce (e.g., edible fruits and vegetables) is often subjected to various processing and treatments to prepare it for sale to consumers. Harvesting, storing, transporting, cutting or trimming, packaging, and other handling of the produce can result in damage to the cells of the produce, also referred to as wounding, due to abrading, scraping, cutting, and peeling of the produce. Indeed, wounding can occur simply due to pressure on a surface of the produce, as a result of storage, for example. Some produce, such as lettuce, is intentionally cut or chopped prior to sale, which results in substantial wounding.

Wounding triggers enzymatic processes involving phenolic compounds and non-enzymatic processes that lead to the production and accumulation of brown pigments in both the damaged and undamaged cells of produce. There is an inverse correlation between wounding intensity and overall visual quality (OVQ) as explained by Pereya (Pereyra et al., SGLWT/SOSSTA 38, 67-72 (2005) (hereby incorporated by reference)). For example, wounding induces one of the primary mechanisms of browning: synthesis of enzymes that increase the production of phenolic compounds. Phenylalanine ammonia lyase (PAL) and polyphenoloxidase are examples of enzymes associated with browning. In lettuce, for example, PAL is a precursor of metabolic production of phenolic compounds that can react with atmospheric oxygen and the enzyme polyphenol-oxidase (PPO) to produce some of the compounds responsible for the discoloration in lettuce. This discoloration process is referred to as enzymatic browning, and, when occurring in lettuce, is commonly referred to as “pinking” by the produce industry. With PAL activity increase, pinking increases and OVQ decreases.

Browning of produce significantly impacts its desirability and browned produce is typically unsellable. Consequently, the occurrence and prevalence of browning is often the limiting factor in the marketable shelf-life of commercial produce.

In one technique for dealing with wound-induced browning, described in U.S. Pat. No. 6,113,958, produce is subjected to a chemical-free heat-shock treatment. The thermal stress on the produce resulting from the heat-shock treatment resulted in the synthesis of heat-shock proteins (HSPs). Indeed, heat-shock proteins are typically characterized by their marked increase in expression in response to cellular exposure to elevated temperatures. With respect to browning, the increased expression of HSPs inhibits the synthesis of browning enzymes, such as PAL, by diverting the cellular protein synthesis mechanisms of the produce to the production of the HSPs.

Specifically, U.S. Pat. No. 6,113,958 describes immersing excised lettuce mid-rib sections in a hot water bath at 680 F, 860 F, 1040 F, 1220 F, 1400 F, and 1580 F and provides various findings regarding PAL activity, the accumulation of phenolic compounds, and the resulting effect on the produce. The patent concludes that exposure to heat-shock at 680 F to 1040 F does not produce a significant alteration in the accumulation of phenolic compounds and that exposure to heat-shock at temperatures from 1400 F to 1580 F causes undesirable, heat-related injury to the lettuce tissue. Thus, the patent states that heat-shock treatment is effective at reducing browning at treatment temperatures within the range of 1040 F to 1400 F.

However, heat-shock treatment techniques administered to address browning can negatively affect the quality of produce through mechanisms other than immediately observable heat-related injury. In cut lettuce processing for pre-packaged salad products, for example, while a heat-shock treatment between 1040 F and 1400 F may reduce browning in the mid-rib portion of lettuce, the treatment can affect the green leaf portion of the lettuce in an adverse manner. In particular, the heat-shock treatment can cause premature decay of the leaves during an expected shelf-life. Premature decay occurs because the heat-shock treatment can damage the respiratory system of the lettuce, leading to early cellular decay and a reduction in OVQ. For example, Reinaldo-Campos (Reinaldo-Campos et al., Physiol. Plantarum 23, 82-91 (2005) (hereby incorporated by reference)) found that heat shock treatments reduce overall enzymatic “pinking” of lettuce. However, using the heat shock treatments suggested by this previous reference, the overall organoleptic quality (as defined by the overall visual quality or OVQ) is considerably reduced, decreasing salable shelf life of finished products, and therefore preventing commercialization. The decrease in quality due to the previous reference's recommended heat-shock treatments makes the product unsalable before the minimal time (16 days) needed from a logistical standpoint.

One of the ways lettuce can be processed for heat-shock treatment involves an apparatus in which the lettuce is submerged in a column of water. The temperature of the water may be regulated in order to subject the produce to a heat-shock treatment if desired. In order to move the lettuce through the column without the use of impellers or other mechanical means which directly contact the produce and can potentially damage the produce, it is necessary that pressure be applied to the column of water. This pressure results in the movement of the resident water column and the submerged produce through the apparatus. The pressure to which the produce is subjected while in the column of water can cause “water intrusion” or “water spotting” on the produce. Increased water spotting has a detrimental effect on the overall visual quality of the produce and can reduce its shelf-life and salability.

Accordingly, there is a need for a method of preventing or limiting wound-induced browning and water spotting that does not lead to other detrimental conditions such as premature decay of produce and decrease of overall visual quality.

### SUMMARY

The present disclosure provides a method for addressing browning of produce, especially fresh-cut produce. In one embodiment of a heat-shock treatment with reduced negative effects, produce is heat-shocked at temperatures in a range of 950 F to 1030 F. Within this range, the production of wound-induced browning is inhibited, while negative leaf decay is minimized. The inhibition of browning increases the marketable shelf-life of the produce.

In one embodiment of a method treating commercial produce to reduce browning and improve marketable shelf-life, the method involves submerging produce, with tissue previously wounded during process, in a liquid at a temperature between 95° F. and 103° F. for 180 seconds or less; the produce is them removed from the liquid; dewatered; and packed in an oxygen-controlled package for commercial sale.

In one embodiment of a method treating commercial produce to reduce water spotting and improve marketable shelf-life, the method involves submerging produce, with tissue previously wounded during process, in a liquid at a temperature between 95° F. and 103° F. for 180 seconds or less, at a water pressure range between 0.5 to 3 psig, and preferably at 1.5 psig, and cooling the produce by submerging the produce in a liquid a temperature of 380 F or less.

### BRIEF DESCRIPTION OF FIGURES

The present application can be understood by reference to the following description taken in conjunction with the accompanying drawing figures, in which like parts may be referred to by like numerals:

FIG. 1 depicts an exemplary process for preparing pre-cut, ready-to-eat, romaine, involving a combined heat-shock treatment to control browning;

FIG. 2 depicts one embodiment of an apparatus for heat-shock treatment of produce;

FIG. 3 depicts an exemplary process for preparing pre-cut, ready-to-eat, romaine, involving a combined heat-shock and anti-microbiological treatment to control browning and to kill microbiological organisms;

FIG. 4 is a graph depicting the discoloration results for each of the three treatments and control;

FIG. 5 depicts the visual scale used to measure lettuce discoloration (i.e., browning);

FIG. 6 depicts microbiological reduction (APC) testing results;

FIG. 7 depicts microbiological reduction (E. Bac) testing results;

FIG. 8 depicts production of trans-cinnamic acid in heat-shock treated and untreated (control) romaine lettuce over a period of 7 days;

FIG. 9 depicts the visual scale used to measure lettuce decay;

FIG. 10 depicts results of decay scores for high temperature treatment and control at the specified times;

FIG. 11 depicts CO₂/O₂ respiration rates for four heat-shock treatments and control;

FIG. 12 depicts qualitative and quantitative measurements of pinking, decay, organoleptic properties, and O₂/CO₂ measurements on day 7;

FIG. 13 depicts qualitative and quantitative measurements of pinking, decay, organoleptic properties, and O₂/CO₂ measurements on day 10;

FIG. 14 depicts qualitative and quantitative measurements of pinking, decay, organoleptic properties, and O₂/CO₂ measurements on day 14;

FIG. 15 depicts qualitative and quantitative measurements of pinking, decay, organoleptic properties, and O₂/CO₂ measurements on day 17;

FIG. 16 is a graph depicting the discoloration results for three temperature treatments and control at the specified times;

FIG. 17 depicts the results of decay scores for three temperature treatments and control at the specified times;

FIG. 18 depicts production of trans-cinnamic acid for three temperature treatments and control at the specified times;

FIG. 19 depicts one embodiment of a lab scale apparatus used to test water pressures and temperatures;

FIG. 20 depicts the visual scale used to measure lettuce water spotting.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments of methods and systems for the improved handling of commercial produce are described below. Generally, these methods and systems may be used with any commercial produce that experiences detrimental browning, such as berries, tree fruits, and leafy vegetables, particularly lettuces such as romaine lettuce and iceberg lettuce. These methods and systems are particularly useful for produce having soft tissue, low pigmentation, and/or produce that experiences substantial handling during the course of normal processing, resulting in wounding and browning that is detrimental to marketable shelf-life. Prepackaged, ready-to-eat lettuce products, in particular, may benefit from the methods and systems described herein.

### Heat-Shock Treatment

In one embodiment, a method for extending the marketable shelf-life by reduced or delayed browning is employed as part of the processing of romaine lettuce (Lactuca sativa L. var. longifolia) into a pre-cut, ready-to-eat product. Typically, the commercial handling of romaine involves several steps that result in wounding of the lettuce tissue. The preparation of pre-cut, ready-to-eat, romaine products includes wound-inducing steps such as cutting, packing, washing, and de-watering (drying). Left unchecked, the wounding resulting from processing can induce browning, which reduces the marketable shelf-life of the package product.

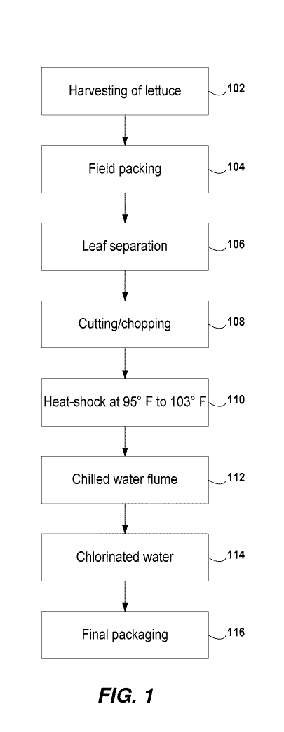

FIG. 1 depicts an exemplary process for preparing pre-cut, ready-to-eat, romaine. In step 102, the romaine lettuce is harvested in the field by cutting the stem of the plant, separating the leafy top portion from the root portion. Step 102 necessarily wounds tissue in the basal portion of lettuce leaves. This wounding may instigate browning processes throughout a significant portion of the lettuce, even if the wounded tissue is ultimately discarded prior to packaging.

In step 104, the top portion of the lettuce is packed into cardboard cartons for transport to a processing facility. Step 104 may also cause wounding, as pressure is applied to the lettuce tissue.

In step 106, the individual leaves are separated. The separated leaves are then cut into pieces in step 108, which necessarily and significantly wounds the lettuce tissue. Separation and chopping may be performed in conjunction, or chopping may precede leaf and core separation.

The chopped romaine lettuce is then subjected to a heat-shock treatment in step 110. In step 110, the chopped lettuce is completely submerged in water maintained at a temperature from 95° F. to 103° F. The chopped lettuce is submerged for a period of less than 180 seconds, preferably 90 seconds.

In step 112, the heat-shocked lettuce is subsequently passed through a chilled water flume (35° F. to 38° F.) to rapidly cool the lettuce. After chilling, the lettuce pieces are sprayed with chlorinated water in step 114 to kill microbiological organisms or microbes. Final packaging of the lettuce occurs in step 116.

In alternative embodiments, heat-shocking may occur at different times in the overall processing, including after anti-microbial treatment or even just prior to wound-inducing steps or in conjunction with wound-inducing steps.

Heat-shocking may be performed with unadulterated water or a variety of liquids, such as chlorinated water, water with chlorine dioxide, water with ozone, water with acids (e.g., citric or acetic acid), or a combination of the above, or other liquids used in the handling of commercial produce.

Additionally the cooling process after heat shocking can be performed with unadulterated water or a variety of liquids, such as chlorinated water, water with chlorine dioxide, water with ozone, water with acids (e.g., citric or acetic acid), or a combination of the above, or other fluids used in the handling of commercial produce. The produce may also be air cooled or vacuum cooled with cold temperature air or with cryogenic gases.

Heat shocking should be performed at temperatures at or over 95° F. to sufficiently inhibit the production of browning enzymes such as PAL. Conversely, heat-shocking should be performed at temperatures at or below 103° F. to avoid accelerated decay of the lettuce, as discussed above. Treatment duration can range from 60 to 180 seconds, depending on other processing variables, such as temperature. For example, use of lower temperatures may require increased treatment duration, and vice versa.

In alternative embodiments employing a heat shock treatment as described herein, one or more of the processing steps may be omitted, replaced, and/or used in conjunction with other processing steps. Additional processes may include, but are not limited to, a hot-temperature sanitation process (i.e., simultaneous heating and washing process), treatment with acidifying agents (e.g., citric or ascorbic acid, but not limiting to these two), and treatment with oxidizing chemicals (e.g., chlorine, ozone, chlorine dioxide, but not limited to these). Other additional steps may occur earlier in the handling process. For example, the lettuce may be transported from the field to a processing facility, prior to step 106. Step 106 may also be preceded with a pre-cooling or vacuum cooling step.

Controlled-atmosphere techniques may also be employed. Controlled atmosphere refers to techniques for exposing produce to a regulated atmosphere so as to enhance or delay the ripening process and/or delay the deterioration of the produce (due to, for example, microbiological organisms, excessive or not enough moisture, etc.). Often, the concentration of oxygen, carbon dioxide, and nitrogen is regulated in a controlled atmosphere. Additionally, temperature and humidity may also be regulated.

Produce may also be treated with modified atmosphere techniques. Modified atmosphere refers to techniques for modifying the internal gas composition of a package that holds the produce so as to improve shelf-life. Such packages are often called modified atmosphere packaging (MAP). As with a controlled atmosphere, the concentration of oxygen, carbon dioxide, and nitrogen is regulated in MAP. Often, the oxygen levels are decreased while the carbon dioxide and nitrogen levels are increased. Modifying the atmosphere in this manner can delay the ripening of produce, reduce respiration, and reduce ethylene production. However, completely eliminating or reducing oxygen content to close to zero can lead to anaerobic metabolism and/or fermentation of the produce, and may also facilitate the growth of anaerobic bacteria. MAP may employ oxygen-transmission-controlled packaging to regulate the rate of oxygen flow to the packaged produce. As mentioned, it is desirable to permit some oxygen into the packaging. Typically, oxygen-controlled packaging is rated by oxygen transmission rate (OTR). For example, a 120 OTR film permits the introduction of 120 cubic centimeters (cc's) of oxygen per 100 sq. inches of film in a 24 hour period, while a 200 OTR film would permit the introduction of 200 cc's of oxygen per 100 sq. inches in 24 hours, under similar conditions. In addition to controlling oxygen, packaging may also control other parameters such as water vapor and/or carbon dioxide concentration. Typically, a desired MAP product is created by injecting nitrogen gas in the package to displace the normal atmosphere and targeting a specific oxygen content, such as 2% or 5%.

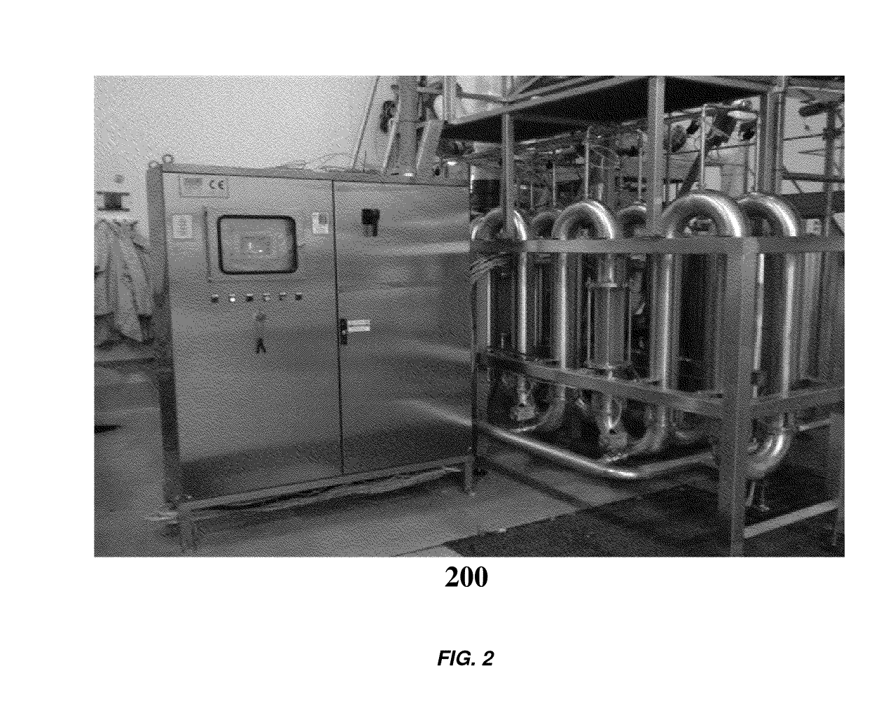

FIG. 2 depicts one embodiment of an apparatus 200 for heat-shock treatment of produce, particularly adapted for the treatment of chopped romaine lettuce. Apparatus 200 has the ability to control water temperature to +/−5° F. while completely submersing the chopped product. Apparatus 200 can measure water temperature at both the inlet of the apparatus and at the outlet of the apparatus. Lettuce residence time in the apparatus is controlled by controlling the speed of a motor a pump that is responsible for conveying the water and submerged product, respectively, through the apparatus. In use, apparatus 200 can treat up to approximately 1000 lb of lettuce, per hour when operating at a residence time of 90 seconds. Apparatus 200 is configured to move the lettuce in a plug flow from inlet to outlet such that the product is treated in a first-in-first-out (FIFO) manner: this ensures consistency of treatment. Further, apparatus 200 minimizes mechanical damage to the lettuce by avoiding the use of impeller pumps, relying instead on the flow of water to transport the fluid.

To prevent excessive or uncontrolled heat exposure, apparatus 200 controls the temperature of water entering at the inlet, prior to introduction of the lettuce. Additional heat and/or heated water is not applied, as doing so may result in localized over-heating of product. It should be appreciated that the overall quality of packed, commercial produce is often impacted by a small percentage of damaged or inferior produce in the package. Accordingly, uniformity of treatment, even when handling large quantities of produce, is desirable. Because apparatus 200 does not apply additional heat, it is expected that water temperature will drop, to a small degree, between the inlet and outlet of apparatus 200. Thus, treatment temperature, as used in this disclosure, refers to the temperature of the treatment liquid at the time the produce is first submerged.

In some embodiments, the ratio of produce to water is 1 part produce to 12-20 parts of water (or other treatment liquid), by weight. As the ratio of produce to water decreases (i.e., there is a greater percentage of water), the temperature drop between the inlet and outlet decreases. For example, if a 5° F. drop is observed at a ratio of 1:17, the drop can be decreased by decreasing the ratio to 1:20.

As discussed in more detail below, heat shock treatments according to the present disclosure may significantly inhibit browning, as evidenced by reductions in PAL activity. For example, PAL activity may be 30%, 25%, 20%, 15%, or 10% less in treated produce as compared to similarly handled, but not heat-shock treated, produce.

### Combined Heat-Shock and Anti-Microbiological Treatment

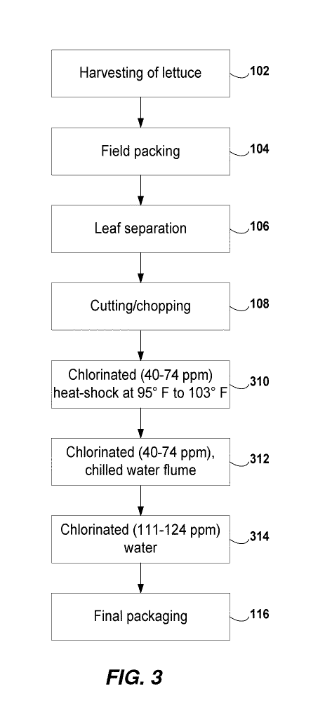

FIG. 3 depicts an exemplary process for preparing pre-cut, ready-to-eat, romaine, involving a combined heat-shock and anti-microbiological treatment to control browning and to kill microbiological organisms. Steps 102, 104, 106, 108, and 116 are as described with respect to FIG. 1. In step 310, the chopped lettuce is completely submerged in chlorinated water (40-74 ppm of chlorine) maintained at a temperature from 95° F. to 103° F. The chopped lettuce is submerged for a period of less than 180 seconds, preferably 90 seconds. The heat-shocked lettuce is subsequently passed through a chlorinated (40-74 ppm of chlorine), chilled water flume (35° F. to 38° F.) to rapidly cool the lettuce, in step 312. After chilling, the lettuce pieces are sprayed with chlorinated (111-124 ppm of chlorine) water in step 314. Final packaging of the lettuce occurs in step 116. The levels of chlorine are not directly pertinent to the effectiveness of the heat shock treatment and may vary according to each plant and its water quality, HACCP plan and sanitation requirements.

### Impact of Water Pressure on Lettuce Leaves

Another detrimental impact to produce, aside from discoloration, can be caused by ‘water intrusion’ or ‘water spotting’ on many of the fresh produce leaves (this may also be referred to as ‘bruising’, where a dark spot appears on the leaf portion). These water spots on the leaves may cause premature decay during the expected shelf life.

FIG. 2, and associated text, depict one embodiment of an apparatus used for heat-shock treatment of produce, and present the advantages of accurate residence time, heat exposure, non impeller driven product movement, etc. While product is conveyed through the apparatus, it is subjected to a water pressure due to complete submersion in the water flowing through the pipes. This processing may be performed in combination with water temperature adjustments as described in this disclosure.

The water column height from entry or exit point to the bottom most portion of the pipe causes the highest amount of water pressure on the cut produce as it passes through the section. This pressure varies as the produce is transported through the varying heights of the water column as it passes through the enclosed pipes. By processing a cut sample through an apparatus as described, the pressure of the water column depth may cause water intrusion on the product. A direct correlation between the amount of water pressure and the degree of water spotting on the leaves of produce is observed.

As discussed in more detail in Example 8, varying the time and pressures to which cut samples are exposed may significantly decrease water spotting and hence promote the overall improvement of sample quality. Experiments in which residence time and pressures are varied allowed identification of an optimal operating range between 0.5 to 3 psig, ideally 1.5 psig, for the processing of produce that minimizes or eliminates the detrimental quality impact of water spotting, and hence promotes the total quality improvement approach of the present disclosure. While an equipment manufacturer may inadvertently have some apparatus that naturally falls within this range of operating water column pressure, the intention is to combine this recommendation with the heat treatment recommendations of the present disclosure to create a total quality product. This would be applicable to both hot water and cold water treatment apparatus.

### 1. EXAMPLES

### Example 1

### Effect of Heat-Shock Treatment on Browning at Variable Temperatures-Visual Measurement

The anti-browning effects of heat-shock treatment at different temperatures were tested for romaine lettuce and compared to the browning in control lettuce. Three heat-shock temperatures were tested: 105° F. (treatment 1), 100° F. (treatment 2), 95° F. and (treatment 3). The severity of browning in the three treatments and control was determined through visual measurement.

All tests, including control, were performed using chopped romaine, obtained from cooled (38-40° F.) whole head romaine after trimming and cutting and randomly assigned to each treatment and control. For each treatment, approximately 500 pounds of chopped romaine was fed continuously into the heat-shock treatment apparatus as depicted in FIG. 2. Feeding was at a rate of approximately 1000 lb/hr and residence time was uniformly maintained at 90 seconds. After heat-shock treatment, the chopped romaine was conveyed through a chilled water flume (35-38° F.) and sprayed with chlorinated water to bring product temperature below 40° F. Product is then dewatered using centrifugal spin dryers to remove excess water and then packed in finished packs. For this example the finished pack is a Salad Caesar Kit, which contains 7 oz of chopped romaine with a separately-sealed kit (dressing, croutons, condiments), packed with modified atmospheric control (MAP), controlling residual bag oxygen levels to between 2-4%. Control was processed in the exact same manner, without heat-shock treatment.

After final packing, packages from all three treatments and control were stored in refrigerated storage at 38-40° F. for 16 days. Samples from each of the treatments and control were observed for discoloration (i.e., browning) at each of 0, 7, 12, 14, and 16 days of storage.

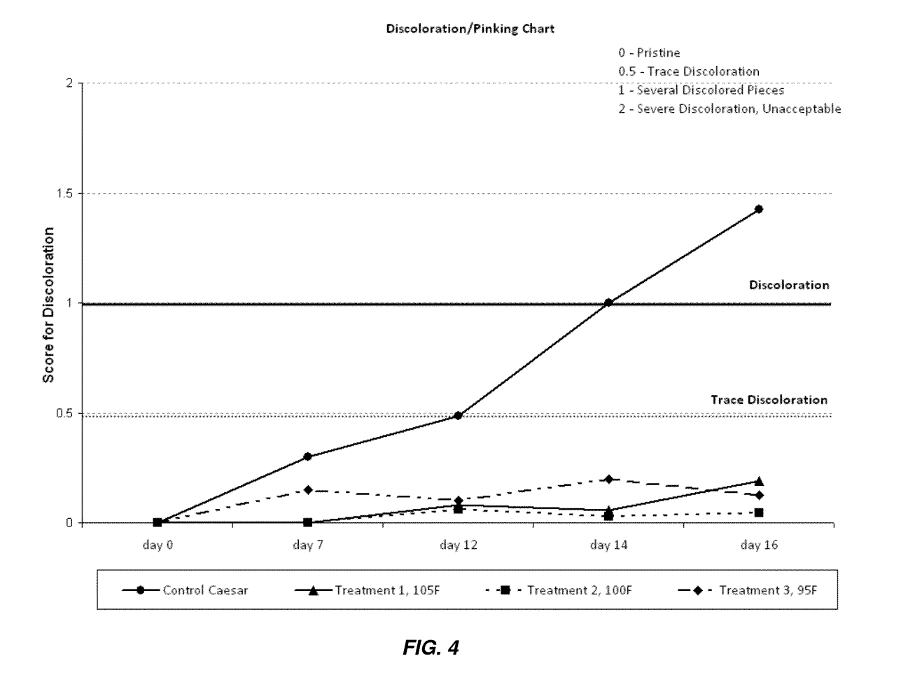

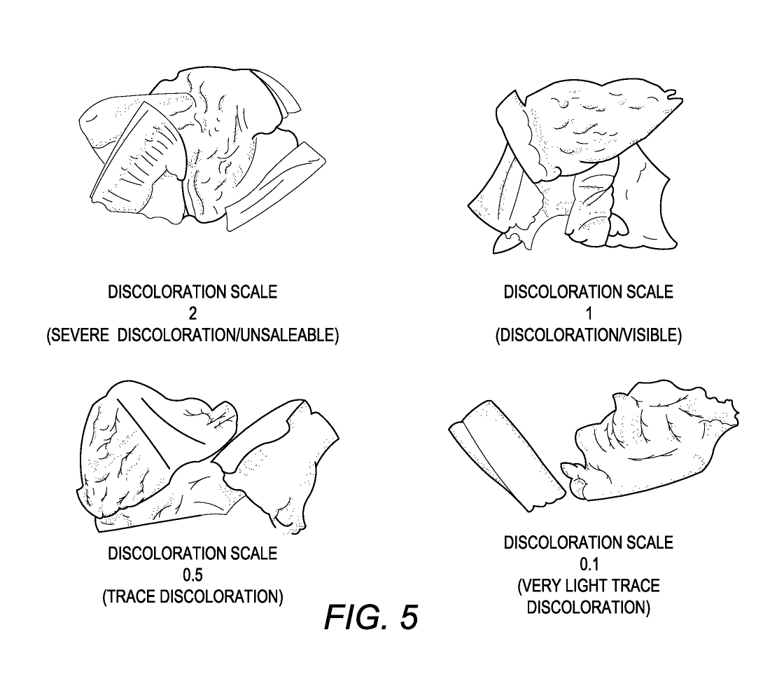

FIG. 4 is a graph depicting the discoloration results for each of the three treatments and control. Measurement of discoloration was performed using the following method for all samples. For each data point, 6-18 bags of packed product were evaluated; all bags were visually and physically inspected to confirm package integrity prior to testing. The number of bags evaluated was adjusted to account for any observational variability: additional bags were evaluated when a high degree of variability was observed (e.g., for later testing time points). Random measurements of internal modified atmosphere were also taken to confirm package integrity no abnormalities were detected. Lettuce from each bag was evaluated and assigned a numerical score from 0-2 on the visual scale demonstrated in FIG. 5. As depicted, 0.1 corresponds to very light, trace discoloration; 0.5 corresponds to trace discoloration; 1.0 corresponds to visible discoloration; and 2.0 corresponds to severe discoloration. In order to maintain consistency, all observations were made by the same observer for all data points throughout the evaluation. Further, the observer was not aware of the providence of each bag, making the observations “blind” with respect to treatment condition. For each tested time point, visual scores for each individual bag of a treatment set were averaged for use in data plotting.

FIG. 4 depicts the results of the visual scores for all treatments and control at the specified times. All three treatments displayed similar levels of discoloration for all sampling points. All three treatments show statistically significant reductions in discoloration, compared to control, from day 10 onwards. Notably, all treatments maintained scores below 0.5 for the duration of the test. In contrast, control progressed to and beyond 0.5 at approximately the 12-day test point.

### Example 2

### Combined Anti-Microbiological and Heat-Shock Treatment at Variable Temperatures

The antimicrobial effects of administering anti-microbiological treatment in combination with heat-shock treatment were tested for romaine lettuce and compared to control treatment, without heat-shocking.

The heat-shocked and control treatments were both performed using chopped romaine, obtained from cooled (38-40° F.) whole head romaine after trimming and cutting and randomly assigned to the heat-shocked and control treatments.

For the heat-shocked treatment, 1000 pounds of chopped romaine was fed continuously into the heat-shock treatment apparatus as depicted in FIG. 2. Feeding was at a rate of approximately 1000 lb/hr and residence time was uniformly maintained at 90 seconds. Testing was performed for approximately one hour and employed approximately 1000 pounds of chopped romaine for each of the heat-shocked and control treatments. Temperature in the heat-shock treatment apparatus was maintained at approximately 103° F. at the inlet. Heat-shock treatment liquid was chlorinated (30-55 ppm of chlorine, actual) and pH-controlled (6-7.0 pH, actual). After heat-shock treatment, the chopped romaine was conveyed through a chilled, chlorinated (45-70 ppm of chlorine, actual) water flume (35-38° F., actual) and sprayed with chlorinated water (125 ppm of chlorine, actual) to bring product temperature below 40° F. Triplicate samples were taken at time intervals of 3 minutes for the 1-hour duration of the test. For each sampling period, triplicate samples were collected for product prior to treatment (i.e., before entering apparatus 200) and after the final chlorinated water spray.

Control lettuce was handled in an identical manner, but without heat-shock treatment. As with the heat-shocked lettuce, triplicate samples were taken at time intervals of 3 minutes for the 1-hour duration of the test. For each sampling period, triplicate samples were collected for product prior to treatment (i.e., before chlorinated water flume) and after the final chlorinated water spray.

Microbiological reduction was calculated taking the triplicate-sample average (both prior and after treatment) at each sampling interval for both heat-shocked and control treatments. Measurement of micro-biological reduction, before and after experimental or control treatment, was performed using the following two methods: aerobic plate count (APC) and Enterobacteriaceae (E. Bac) culture. For the APC protocol, AOAC 990.12 (Dry Rehydratable Film) was employed. For the E. Bac protocol, AOAC 2003.01 (Enterobacteriaceae Count Plate Method) was employed. Both protocols are available from AOAC International.

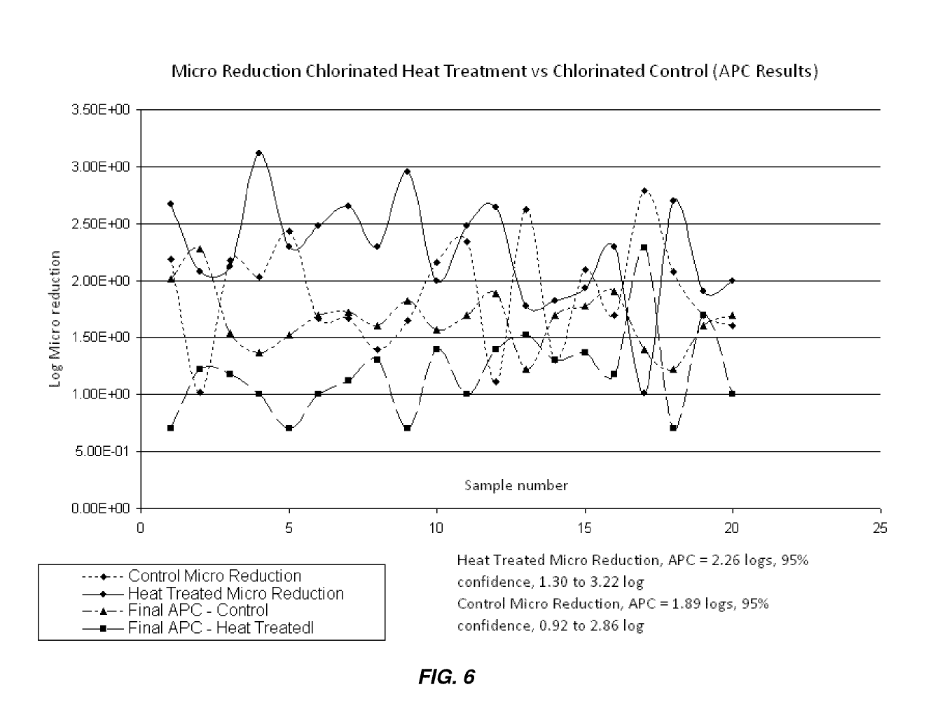

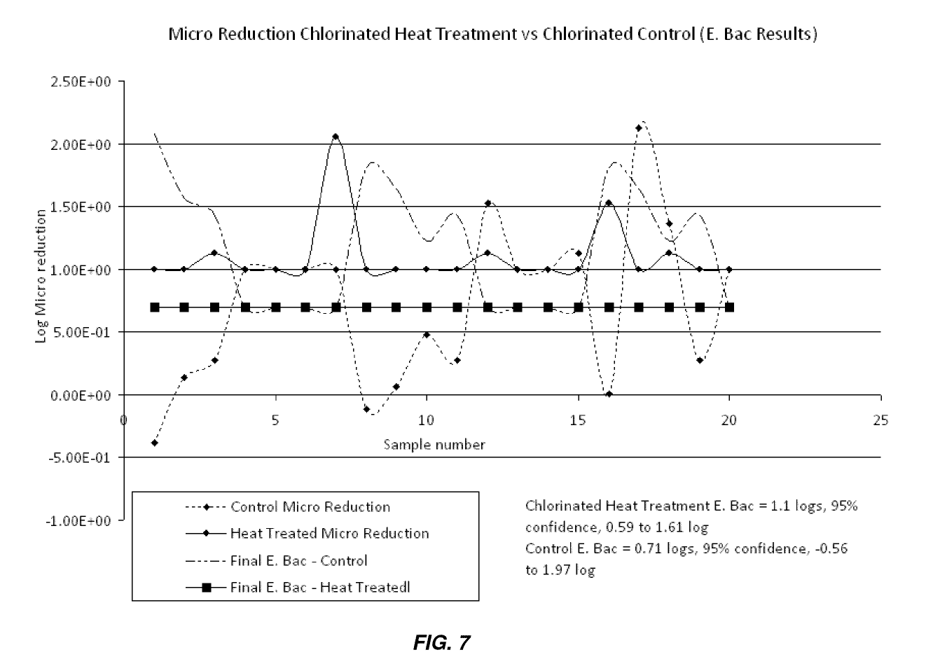

FIG. 6 depicts the APC testing results. FIG. 7 depicts the E. Bac testing results. For the control treatment, the average APC reduction on chopped romaine was 1.89 log CFU/g (95% confidence interval) and E. Bac reduction was 0.71 log CFU/g (95% confidence interval). For the heat-shocked treatment, the combined synergy of relatively low heat (approximately 103° F.) and chlorination with pH control, resulted in an average reduction of 2.26 log CFU/g (95% confidence interval) for APC and 1.1 log CFU/g (95% confidence interval) reduction for E Bac. Final E. Bac culture values for the heat shock treatment were all below the measurement threshold (0.69 log CFU/g) of the protocol. While final E. Bac culture for control was occasionally below the measurement threshold, control showed a greater variability, and therefore less consistent.

Thus, heat-shocked treatment demonstrated statistically significant anti-microbiological effects for both testing methods.

### Example 3

### Effect of Heat-Shock Treatment on Browning at Variable Temperatures-Phenolic Measurement

To further quantify the impact of heat-shock treatment on browning, enzyme-based assays were performed. Trans-cinnamic acid is phenolic compound produced in romaine lettuce by PAL activity, which results in browning. Measurements of trans-cinnamic acid were made on a daily basis to assess the PAL activity in two data sets: heat-shocked and control lettuce riblets.

Heat-shocked and control samples were obtained using the protocol described above for Example 2. Post-treatment chopped romaine for both heat-shocked and control were assayed for PAL activity according to the Iceberg lettuce testing protocol provided in “Effects of calcium and auxin on russet spotting and phenylalanine ammonia-lyase activity in Iceberg lettuce”, as described below. (Ke, D., & Saltveit, M. E. J. HortScience 21, 1169-1171 (1986) (hereby incorporated by reference for its PAL testing protocol)). As used herein, PAL activity refers to activity measured according to the Ke & Salveit protocol.

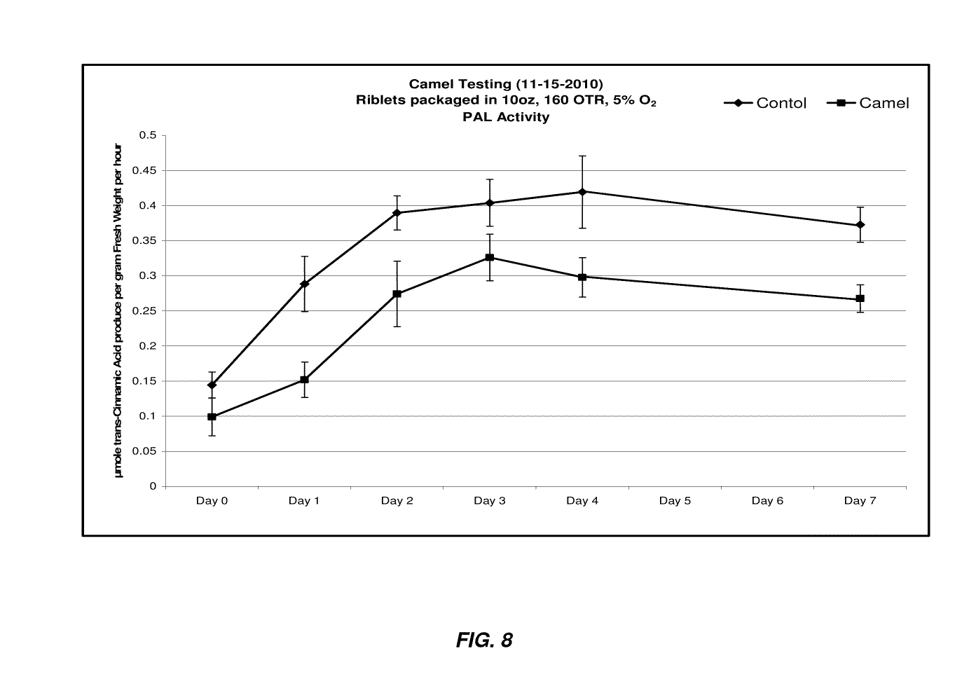

FIG. 8 depicts the production of trans-cinnamic acid in heat-shock treated and untreated (control) romaine lettuce over a period of 7 days. Heat-shock treatment results in a statistically significant reduction in trans-cinnamic acid (i.e., PAL activity) from day 1, onward.

### Example 4

### Comparison of Leaf Decay Impact of High Temperature Heat-Shocking

The leaf decay effects of high temperature heat-shocking was tested for romaine lettuce and compared to leaf decay in control (non-heat-shocked) lettuce. For the high temperature heat-shock treatment (experimental), chopped romaine was submerged in water at 113° F. for 90 seconds. A non-heat-shocked control set was also tested. The severity of leaf decay in the treatment and control was determined through visual measurement.

Both the high temperature and control tests were performed using chopped romaine, obtained from cooled (38-40° F.) whole head romaine after trimming and cutting and randomly assigned to each treatment and control. For high temperature treatment, approximately 500 pounds of chopped romaine was fed continuously into the heat-shock treatment apparatus as depicted in FIG. 2. Water temperature at the inlet was approximately 113° F., feeding was at a rate of approximately 1000 lb/hr, and residence time was uniformly maintained at 90 seconds. After heat-shock treatment, the chopped romaine was conveyed through a chilled water flume (35-38° F.) and sprayed with chlorinated water to bring product temperature below 40° F. The product was then dewatered using centrifugal spin dryers to remove excess water and then packed in finished packs. For this example the finished pack is a 10 oz chopped romaine packed in bags made from two different films: 120 oxygen transmittal rate (OTR) film and 160 OTR film. Residual package oxygen levels to between 2-4%. Control was processed in the exact same manner, without heat-shock treatment.

After final packing, packages from both the high temperature treatment and control were stored in refrigerated storage at 38-40° F. for 17 days. Samples from both sets were observed for leaf decay on days 4, 7, 10, 12, 14, and 17.

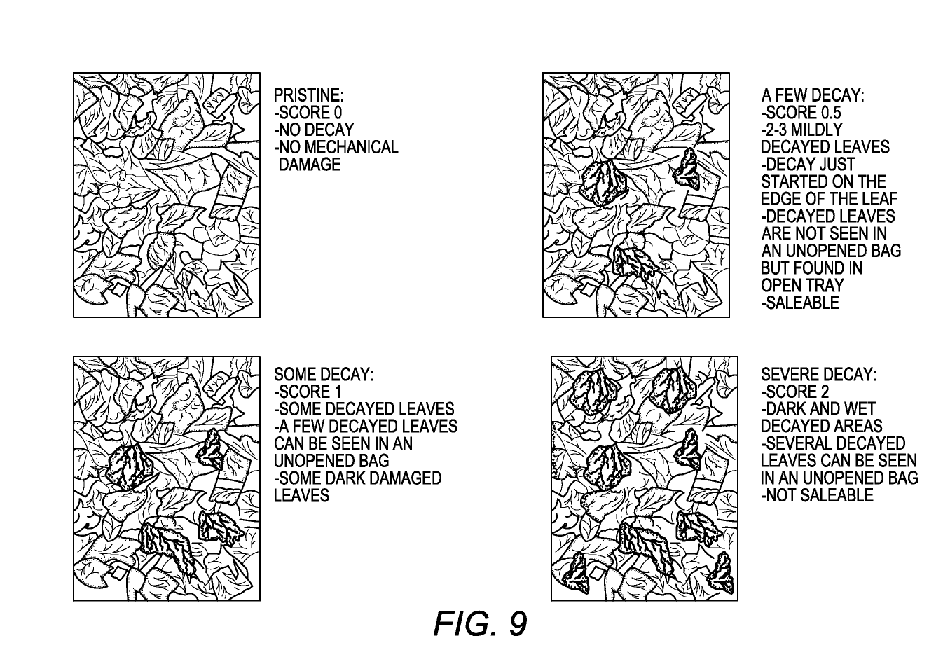

FIG. 9 depicts the visual scale used to measure lettuce decay. Measurement of decay was performed using the following method for all samples. For each data point, 6-18 bags of packed product were evaluated; all bags were visually and physically inspected to confirm package integrity prior to testing. The number of bags evaluated was varied, as per Example 1. Random measurements of internal modified atmosphere were also taken to confirm package integrity no abnormalities were detected. Lettuce from each bag was evaluated and assigned a numerical score from 0-2 on the decay scale demonstrated in FIG. 9. As depicted, 0 corresponds to pristine lettuce, with no decay; 0.5 corresponds to a few indicators of decay, visible at leaf edges; 1.0 corresponds to some decay, with dark damaged leaves; and 2.0 corresponds to severe decay, with dark and wet decayed leaves.

In order to maintain consistency, all observations were made by the same observer for all data points throughout the evaluation. Further, the observer was not aware of the providence of each bag, making the observations “blind” with respect to treatment condition. For each tested time point, visual scores for each individual bag of a treatment set were averaged for use in data plotting.

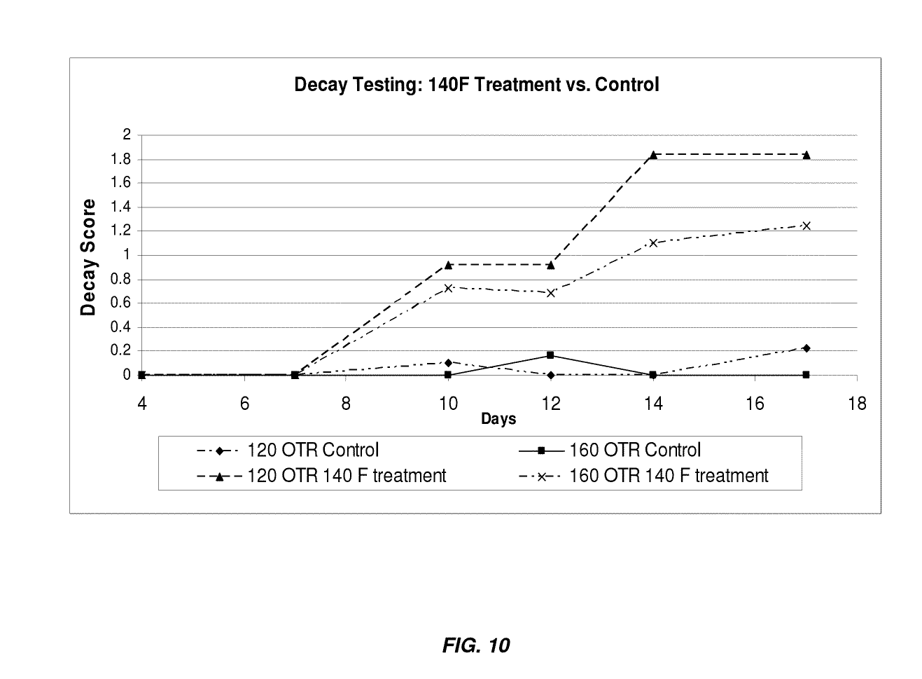

FIG. 10 depicts the results of decay scores for high temperature treatment and control at the specified times, with 120 OTR and 160 OTR results for both. Higher temperature treatment showed significantly increased decay, as compared to control. While high temperature treatment displayed less decay in 160 OTR film when compared to 120 OTR film, both high temperature treatment sets showed significantly increased decay over control treatment in either 120 OTR or 160 OTR film.

In the high temperature treatment set, the appearance of brown edges on the tender portion of the lettuce was apparent early (before day 7 of shelf-life) and progressively got worse as shelf-life progressed. This effect was observed for both the 120 OTR and 160 OTR films. In contrast, a low temperature treatment set (tested under similar conditions on a separate occasion) presented results similar to control: little to no brown edges on the tender portion of the lettuce at day 7 and noticeable, but acceptable browning at day 14.

### Example 5

### Comparison of Leaf Decay Impact of High Temperature Heat-Shocking-Respiratory Measurements

To further quantify the impact of heat-shock treatment on leaf decay, CO₂-based respiratory assays were performed. As discussed above, damage to lettuce respiratory systems is a known cause of leaf decay. Accordingly, measurements of CO₂/O₂ respiration rate were made for romaine lettuce heat treated at four temperatures: 95° F., 100° F., 105° F., and 140° F. Results were compared against control, which was not heat treated.

All tests, including control, were performed using chopped romaine, obtained from cooled (38-40° F.) whole head romaine after trimming and cutting and randomly assigned to each treatment and control. For each of the four heat treatments, samples were prepared by manually submerging 2 pounds of chopped romaine in a 5 gallon bath (maintained at the respective treatment temperature) for 90 seconds. Treatment liquid was chlorinated water (50-100 ppm, actual) maintained at a pH of 6.8-7.2 (actual). After submersion, heat-shocked lettuce was immediately chilled in chlorinated water (50-100 ppm, actual) at 38° F. Chilled product was dewatered in a centrifuge until surface moisture level was in the range of 3.9% to 5.9%. Six lots were prepared for each treatment, resulting in 12 pounds of sample for each treatment temperature. Control was 12 pounds of chopped romaine that underwent identical chilling and dewatering, without heat treatment.

CO₂/O₂ respiration rates were measured using respiration rate pails. Gas measurements were made using a Bridge Analyzers, Inc. model 900141 headspace gas infrared analyzer. For each treatment and control, three pails were used; each pail was packed with 4 pounds of sample under the same ambient atmosphere (20.95% oxygen, 0.06% CO₂). Percentage of CO₂/O₂ was measured after 1-hour of hold time. As used herein, CO₂/O₂ respiration rates refer to rates measured according to this protocol.

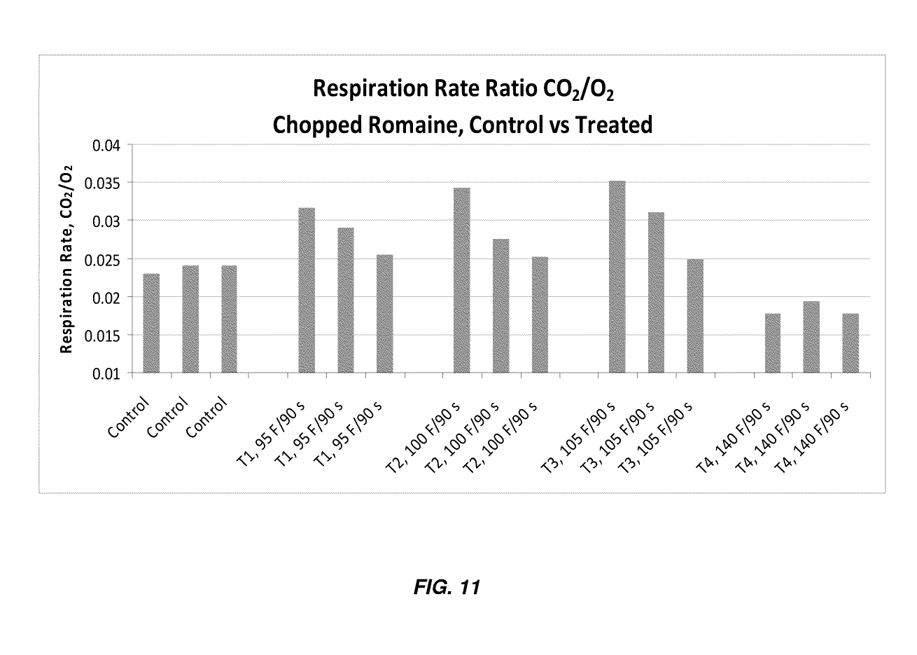

FIG. 11 depicts the triplicate results for each of the 4 heat-shock treatments, and control. Heat-shock treatments at 95° F., 100° F., and 105° F. showed respiration rates greater than or comparable to control. However, heat-shock treatment at 140° F. demonstrated significantly decreased respiration rates, indicating the potential for early decay. Values for FIG. 11 shown in the following table.

TABLE 1
CO₂/O₂ respiration rates

| | | | Respiration |
|---|---|---|---|
| | | O₂ | Rate Ratio |
| Set | CO₂ (%) | (%) | CO₂/O₂ |
| Control | 0.47 | 20.46 | 0.023 |
| Control | 0.49 | 20.41 | 0.024 |
| Control | 0.49 | 20.41 | 0.024 |
| T1, 95 F./90 s | 0.64 | 20.25 | 0.032 |
| T1, 95 F./90 s | 0.59 | 20.29 | 0.029 |
| T1, 95 F./90 s | 0.52 | 20.4 | 0.025 |
| T2, 100 F./90 s | 0.69 | 20.13 | 0.034 |
| T2, 100 F./90 s | 0.56 | 20.27 | 0.028 |
| T2, 100 F./90 s | 0.51 | 20.28 | 0.025 |
| T3, 105 F./90 s | 0.71 | 20.17 | 0.035 |
| T3, 105 F./90 s | 0.63 | 20.26 | 0.031 |
| T3, 105 F./90 s | 0.51 | 20.42 | 0.025 |
| T4, 140 F./90 s | 0.37 | 20.76 | 0.018 |
| T4, 140 F./90 s | 0.4 | 20.71 | 0.019 |
| T4, 140 F./90 s | 0.37 | 20.76 | 0.018 |

### Example 6

### Effect of Heat-Shock Treatment on Shelf Life at Variable Temperatures

Three heat-shock temperatures were tested: 103° F., 99° F., and 95° F. All tests, including control, were performed using chopped romaine lettuce, obtained from cooled (38-40° F.) whole head of romaine after trimming (removing bottom core of lettuce and some outer leaves) and cutting using a URSCHEL Translicer 2500. For each treatment, approximately 500 pounds of chopped romaine lettuce were fed continuously. The heat-shock treatments were applied by proprietary equipment designed for this process. The feed rate was approximately 1000 lb/hr and residence time was uniformly maintained at 90 seconds. Following heat-shock treatment, chopped lettuce was conveyed through a chilled water flume (35-38° F.) and sprayed with chlorinated water to bring product temperature below 40° F.; the after chilling temperature of the product was between 38° F. and 39° F. Product was dewatered using centrifugal spin dryers to remove excess water. Lettuces were packed into a Caesar Salad Kit (Oriented Polypropylene/Polyethylene film, Oxygen Transmission Rate of 75 cc/100 in²/24 hr), which contains 7 oz of chopped romaine and a separately-sealed kit (dressing, croutons, condiments) and packed with modified atmospheric control (MAP). Product was packed at oxygen levels of 10% to observe pinking retardation, if any, of the various treatment conditions and control, under accelerated pinking conditions. The control was processed in the exact same manner, without heat-shock treatment.

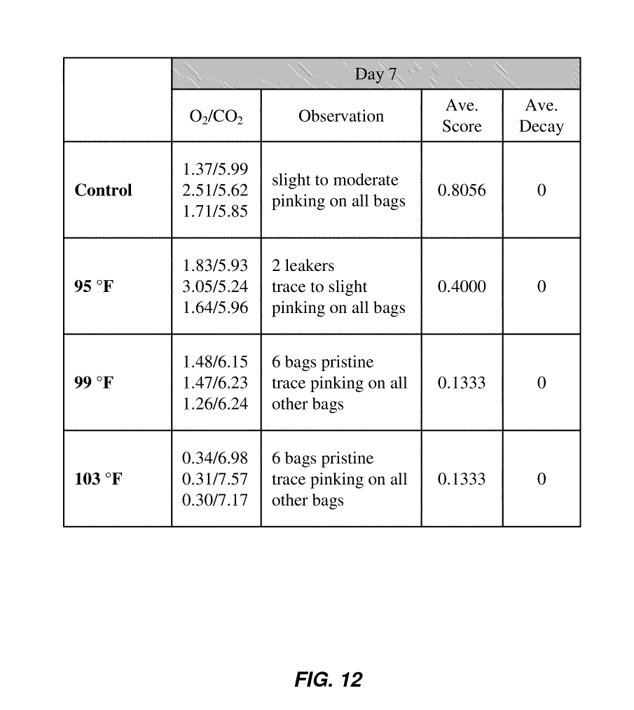

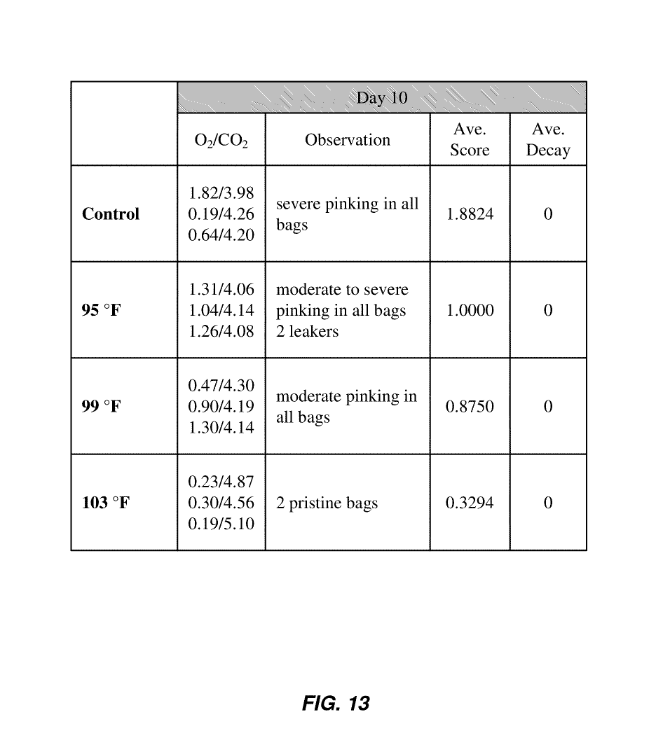

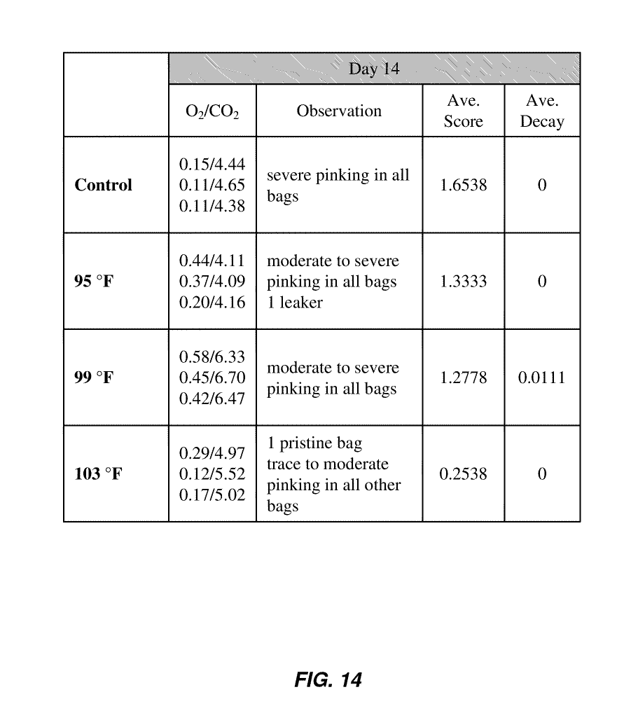

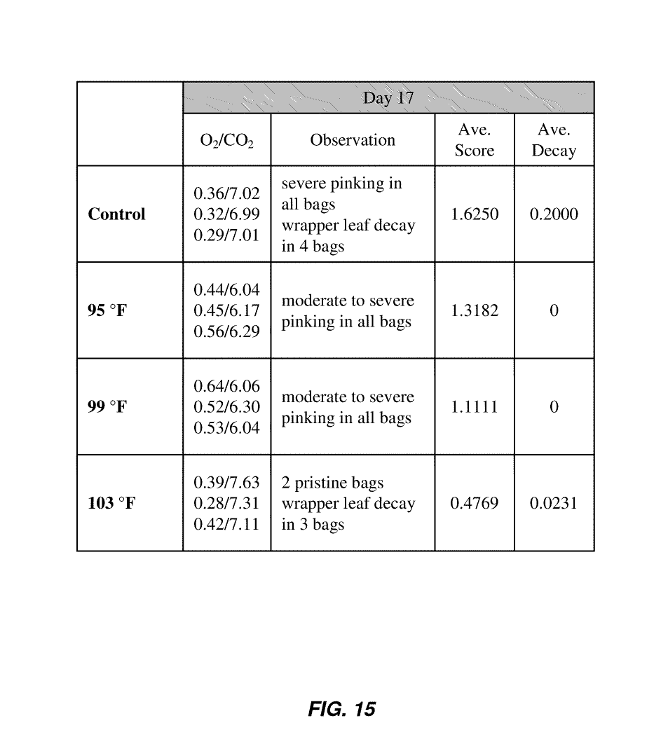

All packages were stored in refrigerated storage at 38-40° F. for 17 days. 9-18 bags from each of the treatments and control were qualitatively assessed for browning (or pinking), decay and organoleptic properties and quantitatively tested for O₂/CO₂ percentage. Any kits found not to be airtight at time of sampling were discarded and not included in the analyses. Three bags, from every treatment group, were randomly selected for O₂/CO₂ measurements. Qualitative and quantitative measurements were taken on days 7, 10, 14, and 17 of storage. Data from these measurements are shown in FIG. 12-15. Briefly, FIG. 12 is data from day 7, FIG. 13 is data from day 10, FIG. 14 is data from day 14, and FIG. 15 is data from day 17.

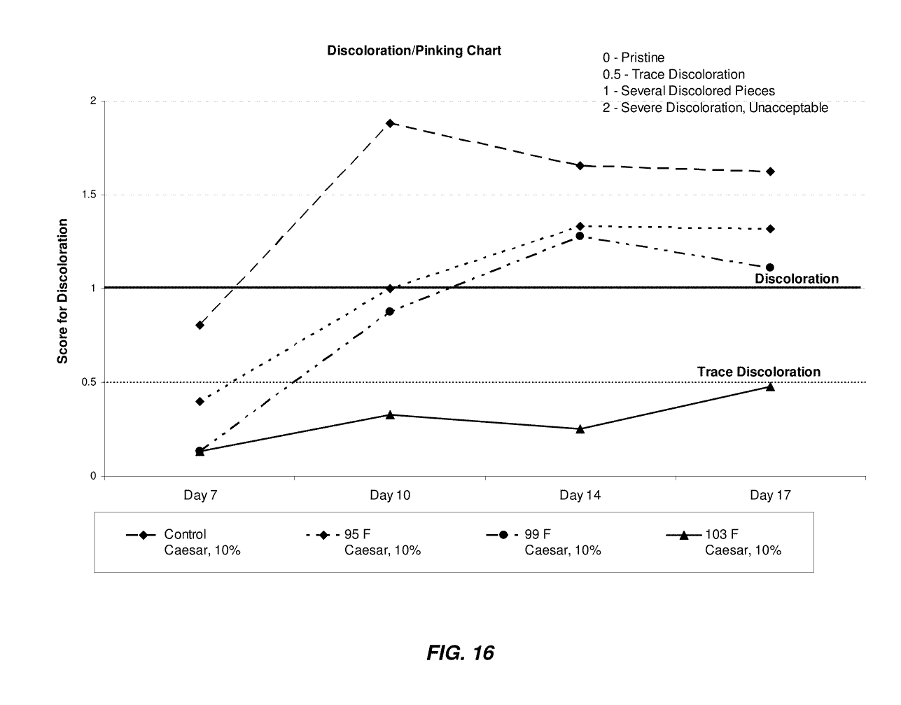

FIG. 16 is a graph depicting the discoloration results for each of the three treatments and control as shown in FIG. 12-15. Measurement of discoloration was performed using the following method for all samples. For each data point, 9-18 bags of packed product were evaluated; all bags were visually and physically inspected to confirm package integrity prior to testing. The number of bags evaluated was adjusted to account for any observational variability: additional bags were evaluated when a high degree of variability was observed (e.g., for later testing time points). Random measurements of internal modified atmosphere were also taken to confirm package integrity no abnormalities were detected. Lettuce from each bag was evaluated and assigned a numerical score from 0-2 on the visual scale demonstrated in FIG. 5. As depicted, 0.1 corresponds to very light, trace discoloration; 0.5 corresponds to trace discoloration; 1.0 corresponds to visible discoloration; and 2.0 corresponds to severe discoloration. In order to maintain consistency, all observations were made by the same observer for all data points throughout the evaluation. Further, the observer was not aware of the providence of each bag, making the observations “blind” with respect to treatment condition. For each tested time point, visual scores for each individual bag of a treatment set were averaged for use in data plotting.

FIG. 16 depicts the results of the visual scores for all treatments and control at the specified times. On day 7, all heat-shock treated samples have a significantly lower level of browning than the control sample and this trend continues through the end of shelf life on day 17. The samples treated with a 103° F. heat-shock have below trace discoloration starting on day 7 and remaining throughout shelf life. Control product shows a higher discoloration trend, with 95° F. and 99° F. samples, showing lower discoloration scores than control. The control and 103° F. heat-shock samples showed trace amounts of decay on the green wrapper leaves on day 17 only, and the 95° F. and 99° F. heat-shock samples were free from decay through the end of shelf life.

Previously, Example 1 (FIG. 4) had shown that all temperature treatments ranging from 95° F.-105° F. were significantly better than non-shock control by day 16 with relatively little variation in the discoloration score among heat-shock treated samples. The higher 10% oxygen concentration in the packing kits of Example 6 allowed both the 103° F. heat-shock treatment to minimize discoloration (FIG. 16), and provided a higher oxygen concentration to mitigate decay.

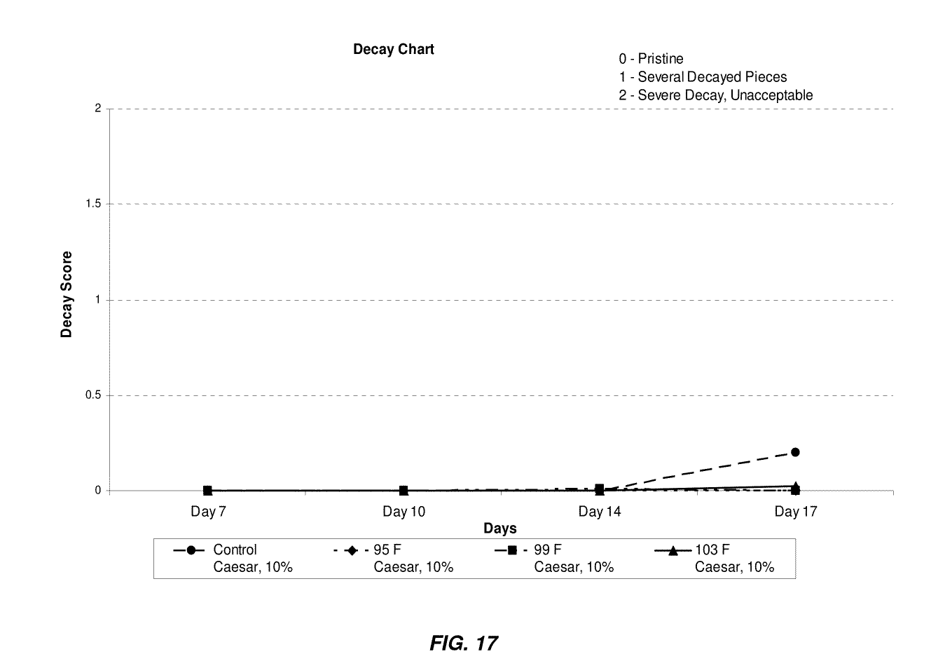

FIG. 17 depicts the results of decay scores for heat-shock and untreated samples at specified sampling times. Heat-shock temperatures, kits with O₂ concentrations of 10% and OTRs of 75, and sampling days are the same as described above for the results of FIG. 16. Under these conditions, heat-shock treatments did not result in significant decay and were similar to the control non heat-shocked treatment. Earlier Example 4 (FIG. 10) tested decay scores of treated lettuce at higher OTRs (120 and 160), lower O₂ concentrations (2-4%) and a heat-shock temperature of 113° F. Under these conditions, a higher OTR of 160 somewhat mitigated the decay induced by the high heat-shock of 113° F. compared to storage under an OTR of 120. However, the heat-shocked samples stored at OTR of 160 still experienced a significantly higher decay score than the untreated control.

In contrast, under the reduced heat shock temperatures of 95° F., 99° F., 103° F. and a reduced OTR of 75 but higher O₂ concentration of 10%, there is only a slight increase in the decay score of the untreated sample. This difference is insignificant, being below the 0.5 decay score threshold for trace discoloration. Thus, heat-shock at 95° F., 99° F., and 103° F. under the packing conditions described, do not result in decay as indicated by decay scores all less than 0.5 by day 17.

Table 2 provides a summary of the quantitative data from the discoloration and decay experiments that were detailed above. Both controls and experimental samples were held in packing with an OTR of 75, and an O₂ concentration of 10%.

TABLE 2
Discoloration and decay summary

| | | | |
|---|---|---|---|
| Day 7 | Day 10 | Day 14 | Day 17 |

Discoloration Scores Summary

| | | | | |
|---|---|---|---|---|
| Control Caesar | 0.8056 | 1.8824 | 1.6538 | 1.6250 |
| 95 F. Caesar | 0.4000 | 1.0000 | 1.3333 | 1.3182 |
| 99 F. Caesar | 0.1333 | 0.8750 | 1.2778 | 1.1111 |
| 103 F. Caesar | 0.1333 | 0.3294 | 0.2538 | 0.4769 |

Decay Scores Summary

| | | | | |
|---|---|---|---|---|
| Control Caesar | 0.0000 | 0.0000 | 0.0000 | 0.2000 |
| 95 F. Caesar | 0.0000 | 0.0000 | 0.0000 | 0.0000 |
| 99 F. Caesar | 0.0000 | 0.0000 | 0.0111 | 0.0000 |
| 103 F. Caesar | 0.0000 | 0.0000 | 0.0000 | 0.0231 |

### Example 7

### Effect of Heat-Shock Treatment on Browning at Variable Temperatures-Phenolic Measurement

To assess PAL activity after heat-shock treatments it was decided to use only the rib tissue portion from the chopped romaine lettuce. There is a difference in PAL activity levels within vegetable tissue. For example, PAL activity increase after trimming is much higher in rib tissue vs. green leaf tissue within the same lettuce head. By assessing PAL activity in riblets after each heat-shock treatment, a more accurate assessment of the effects of each treatment could be determined. The decision to evaluate the efficacy of each treatment in decreasing PAL activity could offer a viable physiological explanation to the lower levels of pinking.

To obtain rib tissue portion from whole romaine heads the following procedure was followed. Whole romaine heads processed into riblets by first cutting the head of romaine in half lengthwise. Romaine halves were then sliced widthwise 2 inches above the core and again 3 inches above the first slice. This middle portion was retained and lettuce leaflets were removed from the ribs. The ribs were then chopped into 0.5 inch segments which will be referred to as riblets. Riblets were treated, processed and packaged similar to shelf life samples.

Three heat-shock temperatures were tested: 103° F., 99° F., and 95° F. After heat-shock treatment, riblets dipped in a chilled bath (35-38° F.) of chlorinated water to bring product temperature below 40° F. Product was then dewatered using centrifugal spin dryers to remove excess water and packed in 5 oz bags of 140 OTR (cc/100 in²/24 hr) laminate film with modified atmospheric control (MAP), controlling residual bag oxygen levels to 5%. Control was processed in the exact same manner, without heat-shock treatment.

After final packing, packages from all three treatments and control were stored in refrigerated storage at 38-40° F. for 7 days. Three bags from each treatment including control were tested for PAL activity at each of 0, 3, 5, 7, days of storage.

PAL Activity Determination.

For each treatment on a testing date, 3 bags were opened and combined to create a heterogeneous mixture. From this, 3 samples were taken and tested for PAL activity. Post-treatment chopped romaine for both heat-shocked and control were assayed for PAL activity according to the Iceberg lettuce testing protocol provided by Ke and Saltveit (1986).

From each combined sample of riblets, 3-4 grams were taken in triplicate and placed in a 50 mL tube and kept on ice throughout the testing protocol. Sample weights were taken and used to calculate a dilution factor to correctly calculate the amount of trans-cinnamic acid produced. To this, 0.2 grams of polyvinylpyrrolidone was added to each tube, and then 25 mL of borate buffer (pH 8.5) was added to each tube. Samples were homogenized for 1-2 minutes to create a slurry. Supernatant was collected by passing lettuce slurry through 4 layers of cheesecloth into a centrifuge tube and centrifuging at 32,000 G for 30 minutes at 2° C. The resulting supernatant was poured off into a clean tube, capped and kept on ice until assay (maximum 4 hours). Two tubes, each containing 5 mL of sample, were placed in a 40° C. water bath for 5 minutes. Samples were removed from the water bath and immediately tested by adding 550 μL of deionized water to one tube (control) and 550 μL of 100 mM L-phenylalanine to the other tube (test) and measured in a spectrophotometer set at λ=290 nm for Time-0 readings. Samples were immediately capped and placed back into 40° C. water bath for exactly 60 minutes. After 60 minutes, samples were taken from the water bath and measured again in the spectrophotometer at λ=290 nm for Time-60 readings. Amount of trans-cinnamic acid produced was then calculated to determine PAL activity in the samples. All sample types, on every sampling day, included a negative control to provide a baseline and to confirm that increases in trans-cinnamic acid were valid observations (data not shown).

Table 3 details the individual absorbance values of samples in every experimental triplicate sample for each sampling date. Table 4 provides a summary of the results of averaging triplicate samples and includes the standard deviation of these results, as well as a brief summary of experimental conditions.

TABLE 3
Trans-cinnamic acid production.

| Control | | | | 95 F. | | | |
|---|---|---|---|---|---|---|---|
| Sample | T-0 | T-60 | μmol of | Sample | T-0 | T-60 | μmol of |
| Date | Abs | Abs | trans- | Date | Abs | Abs | trans- |
| Day 0 | 0.841 | 0.949 | 0.0726 | Day 0 | 0.702 | 0.769 | 0.0420 |
| Day 0 | 0.729 | 0.852 | 0.0869 | Day 0 | 0.876 | 0.993 | 0.0718 |
| Day 0 | 0.686 | 0.778 | 0.0686 | Day 0 | 0.664 | 0.766 | 0.0669 |
| Day 3 | 0.775 | 1.293 | 0.3400 | Day 3 | 0.607 | 0.926 | 0.2198 |
| Day 3 | 0.705 | 1.227 | 0.3509 | Day 3 | 0.645 | 1.008 | 0.2328 |
| Day 3 | 0.832 | 1.264 | 0.3135 | Day 3 | 0.685 | 1.067 | 0.2930 |
| Day 5 | 0.859 | 1.292 | 0.3321 | Day 5 | 0.804 | 1.091 | 0.2201 |
| Day 5 | 0.744 | 1.152 | 0.3042 | Day 5 | 0.802 | 1.126 | 0.2127 |
| Day 5 | 0.797 | 1.184 | 0.2808 | Day 5 | 0.755 | 1.088 | 0.2483 |
| Day 7 | 0.969 | 1.427 | 0.3513 | Day 7 | 0.764 | 1.118 | 0.2380 |
| Day 7 | 0.935 | 1.458 | 0.3604 | Day 7 | 0.826 | 1.181 | 0.2446 |
| Day 7 | 0.803 | 1.258 | 0.3490 | Day 7 | 0.825 | 1.164 | 0.2600 |
| 99 F. | | | | 103 F. | | | |
| Sample | T-0 | T-60 | μmol of | Sample | T-0 | T-60 | μmol of |
| Date | Abs | Abs | trans- | Date | Abs | Abs | trans- |
| Day 0 | 0.675 | 0.716 | 0.0282 | Day 0 | 0.679 | 0.784 | 0.0673 |
| Day 0 | 0.678 | 0.762 | 0.0551 | Day 0 | 0.669 | 0.8 | 0.0926 |
| Day 0 | 0.632 | 0.733 | 0.0775 | Day 0 | 0.61 | 0.741 | 0.0977 |
| Day 3 | 0.658 | 0.939 | 0.2039 | Day 3 | 0.804 | 1.117 | 0.2054 |
| Day 3 | 0.583 | 0.808 | 0.1777 | Day 3 | 0.618 | 0.877 | 0.1879 |
| Day 3 | 0.6 | 0.878 | 0.2196 | Day 3 | 0.671 | 0.922 | 0.1925 |
| Day 5 | 0.786 | 1.053 | 0.1840 | Day 5 | 0.802 | 1.115 | 0.1880 |
| Day 5 | 0.631 | 0.977 | 0.2654 | Day 5 | 0.628 | 0.862 | 0.1612 |
| Day 5 | 0.721 | 1.051 | 0.2461 | Day 5 | 0.879 | 1.16 | 0.1986 |
| Day 7 | 0.787 | 1.102 | 0.2349 | Day 7 | 0.698 | 1.037 | 0.2600 |
| Day 7 | 0.76 | 1.109 | 0.2756 | Day 7 | 0.803 | 1.158 | 0.2446 |
| Day 7 | 0.787 | 1.127 | 0.2343 | Day 7 | 0.78 | 1.123 | 0.2558 |

TABLE 4
Summary of trans-cinnamic acid production.
PAL Trial Summary
Riblets

Ribs Treated in lab in waterbath for 90 seconds
Ribs then cooled in 36° F. water
5 oz, 6 in bags
140 OTR, 5% O2

Chart Data

| Control | PAL Avg | PAL Stdev | 95° F. | PAL Avg | PAL Stdev |
|---|---|---|---|---|---|
| Day 0 | 0.0760 | 0.0096 | Day 0 | 0.0602 | 0.0160 |
| Day 3 | 0.3348 | 0.0192 | Day 3 | 0.2485 | 0.0391 |
| Day 5 | 0.3057 | 0.0257 | Day 5 | 0.2270 | 0.0188 |
| Day 7 | 0.3535 | 0.0060 | Day 7 | 0.2475 | 0.0113 |
| 99° F. | PAL Avg | PAL Stdev | 103° F. | PAL Avg | PAL Stdev |
| Day 0 | 0.0536 | 0.0246 | Day 0 | 0.0859 | 0.0163 |
| Day 3 | 0.2004 | 0.0211 | Day 3 | 0.1953 | 0.0091 |
| Day 5 | 0.2318 | 0.0425 | Day 5 | 0.1826 | 0.0193 |
| Day 7 | 0.2483 | 0.0237 | Day 7 | 0.2535 | 0.0080 |

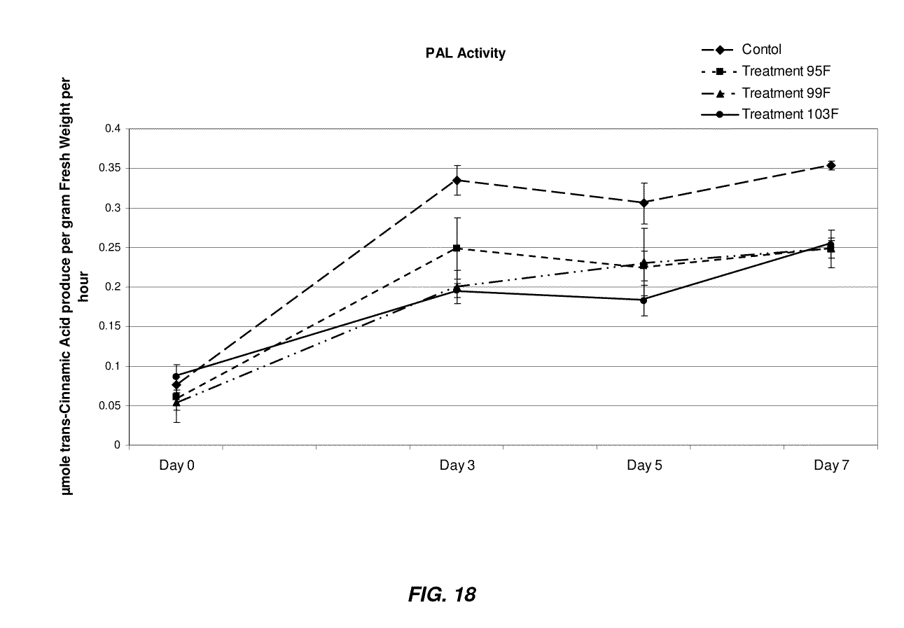

FIG. 18 depicts production of trans-cinnamic acid in heat-shock treated and untreated (control) romaine lettuce over a period of 7 days. By day 3, all of the heat-treated samples showed a lower PAL activity as compared to the control with 99° F. and 103° F. treatments having the lowest PAL-activity. On day 5, the 103° F. treatment remained the lowest for PAL activity and by day 7 all heat-treatments had similar PAL activity. Throughout the test, the treatments maintained a statistically significant lower level of PAL activity as compared to the control.

Earlier Example 3 (FIG. 8) compared untreated sample to a 103° F. heat-shocked sample in kits with 160 OTR and 5% O₂. On day 7, both FIG. 18 and FIG. 8 of the treatment groups had a similar endpoint of 0.25 μmole trans-cinnamic acid produced per gram fresh weight per hour. Thus, heat shock treatment at 95° F., 99° F., and 103° F. all resulted in significantly less trans-cinnamic acid production compared to untreated control.

With these results we demonstrate that lower temperatures than those suggested in previous literature (140° F.) are also effective at lowering PAL activity. The objective in a commercial process is to produce viable quality products through a shelf life span, in this case 14-17 days under controlled and modified atmospheres.

### Example 8

### Impact of Varying Water Pressure and Temperature on Lettuce Leaves

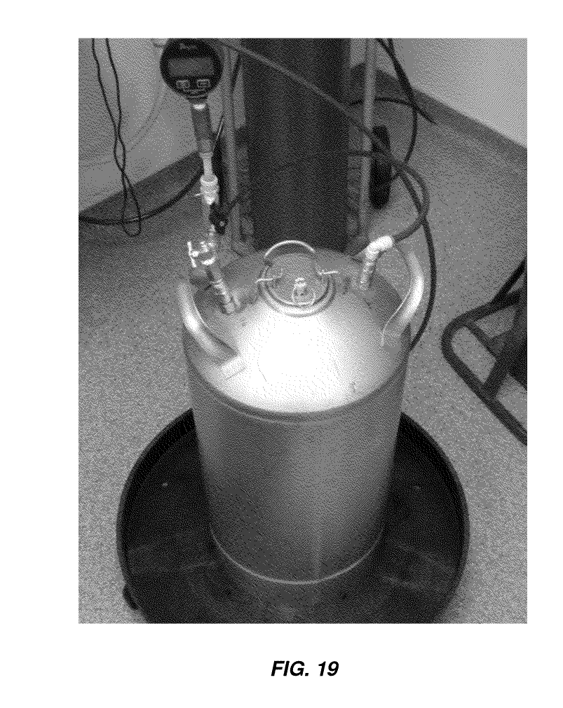

To simulate the impact that water column pressure may be having on the cut produce leaves, a lab scale apparatus was devised (FIG. 19). A CHI Company, 10 gal carbonation tank (model #SVC 10gTT-29764R), was used to establish pressures for the experimental trials. A Dwyre digital pressure gage (model # DPGW-05) was used to track pounds per square inch gage (psig) values. Several experiments were performed in which water pressure, water temperature, and residence times were varied. The sample treatments were evaluated for water spotting intrusion on the produce. Those pieces with water spotting were segregated from non-intrusion pieces, weighed to determine % water spotting, photographed and evaluated with an internal hedonic scale. These evaluations allowed the determination of a recommended operating condition with minimal water pressures and a setting of maximum level which minimizes or eliminates water spotting.

The internal hedonic scale of 0-9 was set up to judge degree of intensity of water spotting on individual leaves. A score of 5.0 and higher would push product beyond acceptability and hence it is desired to produce product under a hedonic score of 5.0 as an internal standard. Obviously, the lower the hedonic score, the better the product appearance and corresponding quality.

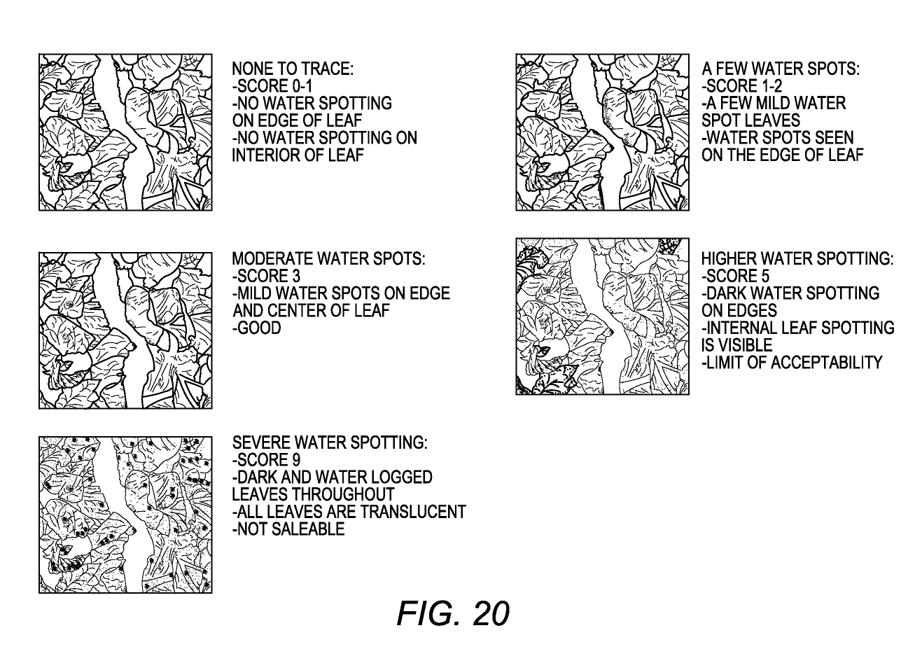

While the amount of leaves exhibiting water spots are represented as a percentage by count or by weight, the degree of water spotting on each leaf (in other words the intensity of water spotting) is reflected as a hedonic score (Table 5 and FIG. 20).

TABLE 5
Visual water spotting scale
Water Spotting Hedonic

| | |
|---|---|
| 0 | None (Excellent) |
| 1 | Trace |
| 2 | |
| 3 | Good |
| 4 | |
| 5 | Limit of Acceptance |
| 6 | |
| 7 | Moderately Severe |
| 8 | |
| 9 | Severe |

It was noted that the greener leaves of the chopped romaine (especially dark green leaves) exhibited a greater amount of water spotting. Hence a variation in raw material, as is expected daily and on a seasonal basis, will have an impact on the degree of water spots. ‘Blonder’ (less green leaf and more white and yellowish tinge material) will exhibit less water spots than a greener product. Since water spots are more readily visible on the greener leaf portions of the cut produce, green leaf portions of chopped romaine and some spinach leaves were chosen for the experiments to judge the impact of water spotting. Hence trials conducted on different days had a built in variability on the amount of green leaves and the normal variations even though the product was first screened to select the green leaf portions for testing.

Control product was tested at 0 psig treatment in the same test apparatus (FIG. 19) to set a baseline and to judge the impact the various pressure settings had on that day's material.

Chopped Romaine pieces, approximately 1.5″×2.0″ were collected from regular processing lines. They were further screened to select the green leaf portions to utilize for the pressure trials. For each trial, pre-weighed samples were submerged inside the CHI pressure tank at the pressure, time and temperature conditions described in the tables below. Submersion water was either heated or chilled per the test requirement. The tank was brought up to test pressures (0 to 20 psig and held for the various test times as indicated).

For trials conducted at temperatures of 103° F., the Romaine samples were poured out into a screened collection container, after pressure submersion. The produce was then doused with 38° F. water to quench excess heat. The product was then placed into a small centrifuge basket to remove excess water. Samples were then spread onto large white trays, for inspection and measurement.

For trials conducted at a combination of Hot and Cold temperatures, i.e. 103° F. for 90 sec, followed by 38° F. for 30 seconds, the same treatment procedure was used as described above. After quenching excess heat, product was returned to the CHI tank (FIG. 19) and subjected to further immersion with water at 34-38 degree ° F. for the required pressure and time combinations. After treatment, product was subjected to the same centrifuge treatment to remove excess water and placed in large white trays for inspection and measurement.

TABLE 6
Water spotting due to varying water pressure, at constant time,
and constant temperature.

| | | | Water | Results | |
|---|---|---|---|---|---|
| | PSI-G | Immersion | Temp | % *WS by | |
| Treatment | Setting | Time-sec | F. | Count | Hedonic 0-9 |
| Control | 0 | 90 | 103 | 0% | 0.5 |
| 4 psi G | 4 | 90 | 103 | 85% | 3.75 |
| 20 psi G | 20 | 90 | 103 | 100% | 9 |

Table 6 shows with increasing treatment pressure, there was an increased degree of water spotting. Water pressure above 4 psig led to extensive damage with 85% or more of samples demonstrating water spotting. Water pressure at 20 psig led to extensive damage indicated by translucent produce.

TABLE 7
Water spotting due to varying water pressure, and varying
time, at constant temperature.

| | | | | | Results | |
|---|---|---|---|---|---|---|
| | | PSI-G | Immersion | Water | % *WS by | |
| Treatment | | Setting | Time-sec | Temp F. | Count | Hedonic 0-9 |
| 2 & 1 | psi | 2 & 1 | 15 & 75 | 103 | 79% | 1.5 |
| 2 & 1 | psi | 2 & 1 | 15 & 75 | 103 | 51% | 1.5 |
| 2 & 1 | psi | 2 & 1 | 15 & 75 | 103 | 70% | 1.5 |
| | | | | Average: | 66% | |
| 1 | psi | 1 psi | 90 | 103 | 62% | 1.5 |
| 1 | psi | 1 psi | 90 | 103 | 53% | 1.5 |
| | | | | Average: | 57% | |

Table 7 shows the results of product subjected to 2 psig for the first 15 sec of immersion and then subjected to 1 psig for the remaining 75 sec of immersion, compared to total immersion at 1 psig. The hedonic scores for these two treatments are similar with no significant differences. This led to an investigation of the impact of time at various pressures and times at the same temperature.

TABLE 8
Water spotting due to varying water pressure, and varying time, at
constant temperature.
Pressure/Time Evaluation for Hand Chopped Romaine

| | Temp at 103 F. | | | | | |
|---|---|---|---|---|---|---|
| PSI-G | Sec | wt. Good | wt. WS* | Total | % WS/wt. | Hedonic 0-9 |
| 0 | 15 | 99 | 9 | 108 | 8% | 0.25 |
| 0 | 60 | 87 | 8 | 95 | 8% | 1.25 |
| 0 | 90 | 69 | 25 | 94 | 27% | 2.5 |
| 1.5 | 15 | 81 | 15 | 96 | 16% | 1.25 |
| 1.5 | 60 | 73 | 25 | 98 | 26% | 2.5 |
| 1.5 | 90 | 60 | 45 | 103 | 43% | 3.5 |
| 3 | 15 | 56 | 44 | 100 | 44% | 2.5 |
| 3 | 60 | 57 | 57 | 114 | 50% | 3.75 |
| 3 | 90 | 57 | 58 | 115 | 50% | 5 |

Table 8 shows that within 15 sec of pressure immersion, water spots already began to be formed and increases in immersion time resulted in increased water spots formation and intensity. Increasing pressure and immersion time increased the water spotting potential. The 1.5 and 3 psig samples showed closer hedonic scores but the degree of spotting as measured by “% WS/wt.” was greater for the samples submersed at 3 psig.

TABLE 9
Water spotting due to varying water pressure, and varying time, at
constant temperature.

| | | Cold Line | | | | |
|---|---|---|---|---|---|---|
| | | Simulation Tank | | | | |
| Tmt | | 38 F. | | | | |
| psi-G | Sec | wt. Good | wt. WS | Total wt. | % WS/wt. | Hedonic 0-9 |
| 0 | 15 | 62 | 2 | 64 | 3% | 1.25 |
| 1.5 | 60 | 35 | 59 | 94 | 63% | 2.5 |
| 3 | 90 | 37 | 38 | 75 | 51% | 5 |

Table 9 shows using chilled water instead of the hot water treatment. Chilled water treatment resulted in a similar trend to hot water treatment (Table 8) in the amount of water spots and the degree of change at the different pressure ranges. There were slight visual differences between 0 and 1.5 psig, and 3 psig resulted in higher water spotting damage. Water spots are formed even when produce is processed with chilled water, as is typical of produce processing. Theoretically, while temperature of treatment may cause some water intrusion, the bigger impact is due to water pressures. Hence water spots are formed irrespective of the hot or cold water treatment.

TABLE 10
Water spotting due to varying water pressure, varying time,
and varying temperature.

Vacuum Cooled Hand
Cut Romaine

| | 103 F. | 90 sec | 38 F. | 30 sec | |
|---|---|---|---|---|---|
| Tmt | wt.- | wt.- | Total | % | Hedonic |
| psig | Good | WS | wt. | WS/wt. | 0-9 |
| 0 | 254 | 36 | 290 | 12% | 1.5 |
| 1.5 | 205 | 83 | 288 | 29% | 1.5 |
| 3 | 164 | 144 | 308 | 47% | 4 |
| 6 | 36 | 251 | 287 | 87% | 7 |

Table 10 shows the cumulative impact on water spots formation and intensity when subjected to a simulated treatment as described in Examples 6-7, namely a combination of heat treatment followed by chilling. Increased pressure produced greater levels of water spotting to the point of translucence by 6 psig; the trend was similar to what was noticed in earlier experiments.

Across experiments in this example, water pressures below 1.5 psig have the least negative impact on samples as measured by the internal hedonic scale and percent water spotting. However the design of the treatment apparatus also incorporates maintaining a head pressure of water from inlet and outlet of the device to maintain a good FIFO (First in First Out, without intermixing) flow of product and water to get the desired treatment without over treating and under treating. As such it may be necessary to provide a greater water column depth, resulting in a greater water pressure beyond 1.5 psig. Water pressures up to 3 psig also have acceptable minimal negative impact on samples as measured by the internal hedonic scale. Thus, an optimal water pressure range between 0.5 and 3 psig, and preferably 1.5 psig, are recommended for the processing of produce in a liquid at a temperature between 95° F. and 103° F. for 180 seconds or less, through an apparatus similar to one described in this disclosure.

We claim:

1. A commercial method of treating produce to reduce browning and improve marketable shelf-life, the method comprising:
obtaining commercially-handled produce, wherein the commercial handling wounds tissue of the produce;
submerging the produce in a liquid at a temperature between 950 F and 1030 F for 180 seconds or less;
removing the produce from the liquid;
dewatering the produce to remove excess liquid; and
packing the produce in an oxygen-controlled package for commercial sale.

2. The method of claim 1, wherein the liquid is chlorinated water.

3. The method of claim 2, wherein submerging the produce in chlorinated water at a temperature between 950 F and 1030 F has an antimicrobial affect, determined by an aerobic plate count (APC) using an AOAC 990.12 protocol, at least 30% greater than the antimicrobial effect observed for a control treatment not submerged in chlorinated water at a temperature between 950 F and 1030 F.

4. The method of claim 3, wherein the antimicrobial affect of submerging the produce in chlorinated water at a temperature between 950 F and 1030 F is a 3.22 log CFU/g reduction or less.

5. The method of claim 2, wherein submerging the produce in chlorinated water at a temperature between 950 F and 1030 F has an antimicrobial affect, determined by an Enterobacteriaceae plate count (E. Bac) using an AOAC 2003.01 protocol, at least 40% greater than the antimicrobial effect observed for a control treatment not submerged in chlorinated water at a temperature between 950 F and 1030 F.

6. The method of claim 5, wherein the antimicrobial affect of submerging the produce in chlorinated water at a temperature between 950 F and 1030 F is a 1.67 log CFU/g reduction or less.

7. The method of claim 1, wherein submerging the produce in liquid at a temperature between 950 F and 1030 F reduces phenylalanine ammonia lyase activity by at least 10% of the phenylalanine ammonia lyase activity observed for produce submerged in an ambient temperature control treatment.

8. The method of claim 1, wherein the packed produce submerged in liquid at a temperature between 950 F and 1030 F has a CO₂/O₂ respiration rate at least 30% higher than packed produce submerged in liquid at a temperature of 1400 F.

9. The method of claim 1, wherein the produce is a leafy vegetable or a fruit.

10. The method of claim 2, wherein the produce is romaine lettuce.

11. The method of claim 1, wherein the liquid is selected from the group consisting of chlorinated water, water with chlorine dioxide, water with ozone, and water with an acidifying agent.

12. The method of claim 1, wherein the liquid comprises an acidifying agent, an oxidizing agent, or a combination thereof.

13. The method of claim 1, wherein the oxygen content of the package is initially between 2-10%.

14. The method of claim 1, further comprising one or more steps selected from the group consisting of: a hot-temperature sanitation process; treatment with acidifying agents, treatment with oxidizing chemicals, and cutting the produce.

15. The method of claim 1, further comprising the step of cooling the produce after submerging the produce.

16. The method of claim 1, wherein the oxygen-controlled package comprises a film having an oxygen transmission rate of 30 to 390.

17. The method of claim 16, wherein the oxygen-controlled package comprises a film having an oxygen transmission rate of 120 to 160.

18. The method of claim 1, wherein submerging the produce in a liquid at a temperature between 950 F and 1030 F for 180 seconds or less comprises submerging the produce in a pressurized flow of liquid at a pressure between 0.5 and 3 psig to reduce water spotting.

19. The method of claim 18, wherein the pressure of the liquid is 1.5 psig.

20. The method of claim 18, wherein the ratio of produce to the liquid is between 1:12 to 1:20.

21. The method of claim 1, further comprising the step of submerging the produce in a liquid at a temperature 380 F or less, after submerging the produce in a liquid at a temperature between 950 F and 1030 F for 180 seconds or less.
